(19) United States
(12) Patent Application Publication
(10) Pub. No.: US 2008/0055417 A1
(43) Pub. Date: Mar. 6, 2008

(54) HANDHELD ELECTRONIC DEVICE

(75) Inventors: WEI-HUAN CHOU, TAIPEI (TW); JIAN-MING PENG, TAIPEI (TW); KAI-CHEN TIEN, TAIPEI (TW); HO-CHING HUANG, TAIPEI (TW); KUN-HUANG HSU, TAIPEI (TW); SHU-HUA LAI, TAIPEI (TW)

Correspondence Address: J C PATENTS, INC., 4 VENTURE, SUITE 250, IRVINE, CA, 92618, US

(73) Assignee: ASUSTEK COMPUTER INC., TAIPEI (TW)

(21) Appl. No.: 11/616,652

(22) Filed: Dec. 27, 2006

(30) Foreign Application Priority Data
Aug. 30, 2006 (TW) 95131989

(51) Int. Cl. H04N 5/225; H04N 9/04

(52) U.S. Cl. 348/207.99

(57) ABSTRACT

A handheld electronic device including a body and an image capturing module. A display is disposed on one surface of the body. The image capturing module is disposed at the body, and includes a lens and a filter unit. The lens is exposed from an opening on the body. Images captured by the lens are displayed on the display. The filter unit includes at least one first filter, one second filter, and a switch. Each of the first filter and the second filter transmits light with different wavelength. The switch is used to switch the first filter and the second filter so that one of the first filter and the second filter is on the light receiving path of the lens.

### CROSS-REFERENCE TO RELATED APPLICATION

This application claims the priority benefit of Taiwan application serial no. 95131989, filed Aug. 30, 2006. All disclosure of the Taiwan application is incorporated herein by reference.

### BACKGROUND OF THE INVENTION

1. Field of the Invention

The invention relates to a handheld electronic device and, more particularly, to a handheld electronic device with the functions of lighting and night vision.

2. Description of the Related Art

In today's information society, the people's dependence on the electronic products is increasing day by day. Responding to a demand for making electronic products light, thin, and small, all kinds of electronic products have been developed with a tendency towards volume-miniaturization. Various kinds of handheld electronic devices are developing flourishingly, and their development makes people more convenient in life and more efficient in mobile communication. Now common handheld electronic devices include, for example, cell phones, personal digital assistants (PDA), global positioning systems (GPS), etc.

A GPS is a navigation system combined with satellite and wireless technology, and it can continuously provide accurate positioning and velocity data for users without being limited by the location, time, and climate. Therefore, a GPS is commonly used as the satellite navigation system of vehicles. In the market, a GPS is also combined with portable electronic devices such as laptop PCs, cell phones, personal digital assistants, etc. This kind of portable electronic devices is commonly used in daily life, and when a user engages in outdoor activities such as climbing, up stream hiking, outdoor survival, etc., he can get the real time forecast of the geographic position to avoid losing his way. However, besides the functions of the GPS itself, the portable electronic devices can only provide the functions of keeping records and information's receiving and sending.

Generally speaking, when a skilled climber engages in outdoor activities such as climbing or up stream hiking, etc., he needs to take not only a GPS but also a stick, a cooker, a flashlight, etc. with him, and sometimes he also needs a pair of night glasses so as to observe wild animals at night without disturbing them. However, the products in the modern market don't integrate the above functions, so the user has to buy various products. This results in not only a waste of money, but also inconvenience of carrying equipments, which is even more troublesome for the climber.

### BRIEF SUMMARY OF THE INVENTION

The objective of the invention is to provide a handheld electronic device, wherein a filter unit is disposed in front of the lens, to switch the filter with different wavelength filtering range. Therefore, the handheld electronic device has the function of infrared night vision besides the normal function of taking pictures, so as to observe the mild animals at night without disturbing them.

To achieve the above or other objectives, the invention provides a handheld electronic device, including a body and an image capturing module. A display is disposed at the surface of the body. An image capturing module is disposed at the body and includes a lens and a filter unit. The lens is disposed at an opening formed on the body, and an image captured by the lens can be displayed on the display. The filter unit is disposed at the body to filter the light through the lens and includes at least a first filter, a second filter, and a switch. Each of the first filter and the second filter transmits light with different wavelength, and the switch is used to switch the first filter and the second filter so that the first filter or the second filter is on the light receiving path of the lens.

In one embodiment of the invention, the above lens is a charge couple device (CCD) or a complementary metal-oxide-semiconductor (CMOS) sensor device.

In one embodiment of the invention, the above first filter is used to transmit infrared light and filters out the light with other wave band, while the second filter is used to transmit visible light and filters the light of other wave band.

In one embodiment of the invention, the above handheld electronic device further includes a control circuit board and a lighting module. The control circuit board is disposed at the body. The lighting module is electrically connected to the control circuit board, and is exposed from the body.

In one embodiment of the invention, the above lighting module includes at least a light-emitting diode (LED).

In one embodiment of the invention, a recess is formed at the surface of the above body, to hold the LED.

In one embodiment of the invention, the above lighting module includes a reflex housing, the reflex housing is disposed in the recess to reflex the light from the LED.

In one embodiment of the invention, the above handheld electronic device further includes a global positioning system (GPS), to produce the forecast of the geographic position of the handheld electronic device.

In one embodiment of the invention, the above handheld electronic device further includes an auxiliary lighting module being disposed at the body, to provide auxiliary lighting source when the image capturing module captures an image.

In one embodiment of the invention, the above auxiliary lighting module is adjacent to the image capturing module.

In one embodiment of the invention, the above auxiliary lighting module includes at least a LED.

In one embodiment of the invention, the above LED is an infrared LED.

In this invention, a filter unit is disposed in front of the lens of the image capturing module of the handheld electronic device, and the filter unit includes a switch and two filters for filtering the light with different wavelength. One of the filters is suitable for transmitting infrared light, and the other is suitable for transmitting visible light. Therefore, when a user uses the function of taking pictures in the daytime, he may use the filter transmitting visible light to filter other light except visible light to prevent producing noise. On the contrary, when a user engages some outdoor activities at night, he may switch to the filter transmitting infrared light for night surveillance, so that it will be favorable for the user to observe wild animals without disturbing them.

These and other features, aspects, and advantages of the invention will become better understood with regard to the following description, appended claims, and accompanying drawings.

### BRIEF DESCRIPTION OF THE DRAWINGS

FIG. 1 and FIG. 2 are three-dimensional schematic diagrams showing the handheld electronic device of the invention from different angles.

FIG. 3 is a cross-sectional schematic diagram showing the image capturing module in the handheld electronic device.

FIG. 4 is the three-dimensional schematic diagram showing the filter unit in the image capturing module.

FIG. 5 is a three-dimensional schematic diagram showing a handheld electronic device according to another embodiment of the invention.

### DETAILED DESCRIPTION OF THE EMBODIMENT

In order to achieve the convenience, when a user engages in outdoor activities, he can get both functions of taking pictures and night surveillance through one handheld electronic device, the invention is provided to dispose a filter unit in front of the lens of the image capturing module in a handheld electronic device and by the switching between two filters for filtering light with different wavelength the handheld electronic device can have the both functions of taking pictures and night surveillance.

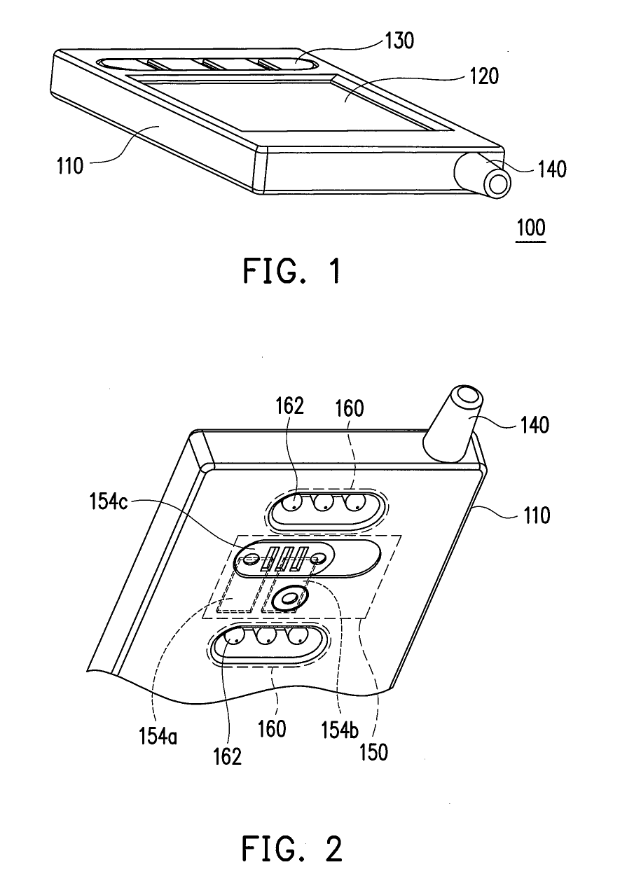

FIG. 1 and FIG. 2 are three-dimensional schematic diagrams showing the handheld electronic device according to an embodiment of the invention from different angles. In the embodiment, the handheld electronic device 100 takes a global positioning system (GPS) for example for illustrate purpose. However, the handheld electronic device 100 also may be other handheld electronic device such as a personal digital assistant (PDA) or a cell phone, etc., and the invention does not limit it. Please refer to FIG. 1 and FIG. 2 simultaneously, the handheld electronic device 100 includes a body 110, a GPS (not shown in the figure), a display 120, a function key 130, an antenna 140 and an image capturing module 150. The GPS gets the real-time forecast of the geographic position through the transmission of satellite signal. The display 120 is disposed on one side of the body 110 to display a map and other information. In the embodiment, the display 120 may be an LCD touch panel, and a user can directly touch the display 120 or the function key 130 below to execute the corresponding function. The antenna 140 is disposed inside the body 110 to receive and send satellite signal.

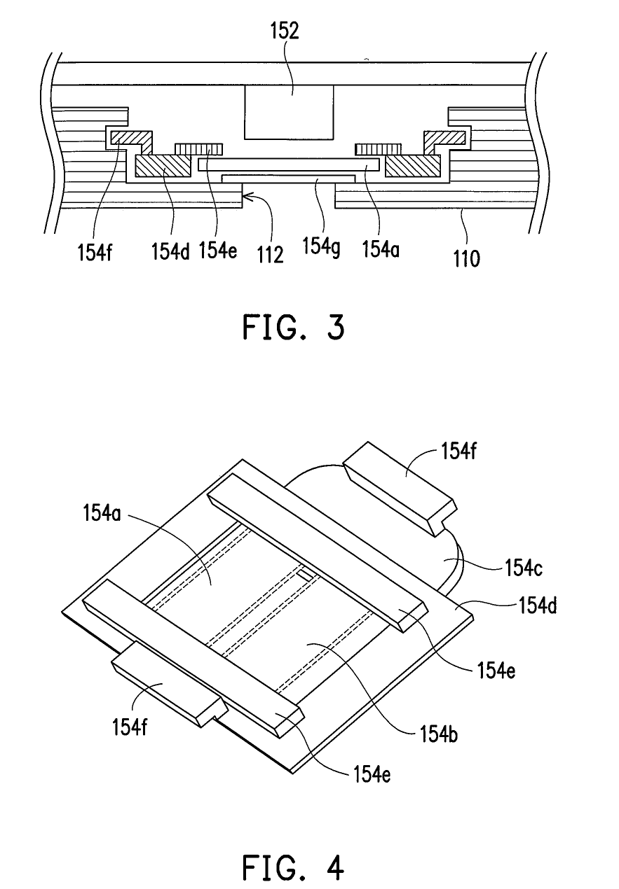

The image capturing module 150 is an element for capturing the image information in the handheld electronic device 100. FIG. 3 is a cross-sectional schematic diagram showing the image capturing module in the handheld electronic device. FIG. 4 is the three-dimensional schematic diagram showing the filter unit in the image capturing module. Please refer to FIG. 2, FIG. 3, and FIG. 4, the image capturing module 150 includes a lens 152 and a filter unit 154. The lens 152 is exposed from the opening 112 on the body 110, and the image information captured by the lens 152 can be displayed on the display 120. In the embodiment, the lens 152 may be a charge couple device (CCD) or a complementary metal-oxide-semiconductor (CMOS) sensor device, which is not limited in the invention. The filter unit 154 mainly includes a first filter 154a, a second filter 154b, and a switch 154c. The first filter 154a and the second filter 154b are suitable for transmitting the light with different wavelength respectively. In the embodiment, the first filter 154a is used to transmit infrared light, and filters out the light with other wavelength, while the second filter 154b is used to transmit visible light, and filters the light with other wavelength. The switch 154c is connected to the first filter 154a and the second filter 154b to switch the first filter 154a and the second filter 154b, so that the first filter or the second filter is on the light receiving path of the lens. Therefore, when a user takes pictures with the handheld electronic device 100 in the daytime, he can switch to the second filter 154b using the second filter 154b to filter other light except visible light to prevent producing noise. On the contrary, when a user engages in outdoor activities at night, he may switch to the first filter 154a to transmit infrared light, and filter the light with other wavelength to provide the function of night vision. Therefore, it will be favorable for the user to see the vision before him clearly through the display 120, when the light is dim with no additional light source available.

Please refer to FIG. 3 and FIG. 4 simultaneously, the filter unit 154 further includes a frame 154d, two fixed press bars 154e, and two guide rails 154f. The first filter 154a and the second filter 154b are fixed on the frame 154d by the fixed press bars 154e on the two ends of the filters. Two guide rails 154f are respectively provided on two ends of the frame 154d, and move relatively to the body 110. The switch 154c is used to switch the first filter 154a and the second filter 154b, so that the first filter 154a or the second filter 154b is on the light receiving path of the lens 152. Furthermore, a protection cover 154g can be disposed on the opening 112 of the body 110 to prevent foreign particles from entering the body 110.

Please refer to FIG. 2, in the embodiment, the handheld electronic device 100 further includes an auxiliary lighting module 160. Therefore, when the intensity of environmental light is insufficient, the auxiliary lighting module 160 can provide an auxiliary light source being needed when the image capturing module 150 captures an image. In the embodiment, the auxiliary lighting module 160 includes several LEDs 162 near to the image capturing module 150. That is to say, the above LEDs 162 may be infrared LEDs. When the image capturing module 150 uses the first filter 154a to capture an infrared image, the infrared LEDs can provide auxiliary infrared light source, to make the user to see the vision before them clearly at night by the display 120. However, persons having ordinary skill in the art can use a different number or kind of the LED, and the invention has no limitation on it.

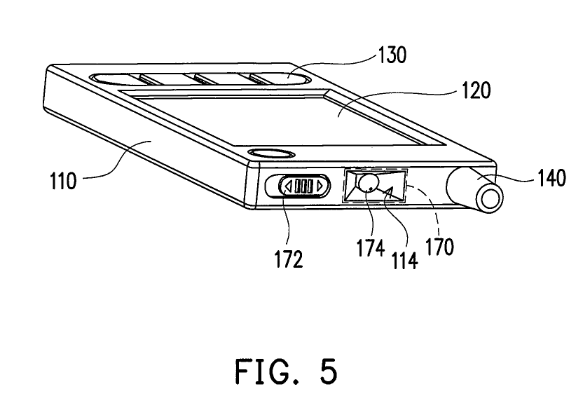

FIG. 5 is a three-dimensional schematic diagram showing the handheld electronic device according to another embodiment of the invention. Please refer to FIG. 5. In order to achieve the convenience, a user can use the GPS of the handheld electronic device 100 and meanwhile he can get the light for lighting when he is outside, a lighting module 170 is disposed additionally on the front end of the body 110 of the handheld electronic device 100 to improve convenience of use.

A control circuit board (not shown in the figure) is disposed inside the body 110 of the handheld electronic device 100, and the lighting module 170 is electrically connected to the control circuit board, and whose open and close operations are controlled by a switch element 172. The lighting module 170 mainly includes at least a LED 174 to provide lighting source needed. The LED 174 is disposed in the recess 114 on the front end of the body 110, to prevent projecting from the body 110, to keep the surface of the body 110 smooth. Furthermore, a reflex housing (not shown in the figure) may be disposed in the recess 114 to reflex the light from the LED 174 and to gather light to improve the directivity and the brightness. In the embodiment, the lighting module 170 only includes a LED 174, while the invention has no limitation on the number of the LED 174. With the lighting module 170, the user can see maps with the display 120, and the device may provide the function of lighting through the lighting module 170 simultaneously, so that the user can observe surroundings clearly to avoid getting lost and the danger caused by poor eyesight.

In summary, the invention provides a filter unit disposed in front of the image capturing module of a handheld electronic device. The filter unit includes a switch and two filters suitable for filtering the light with different wavelength. One of the filters is suitable for transmitting infrared light and filters out the light with other wavelength, while the other filter is suitable for transmitting visible light and filters the light with other wavelength. Therefore, when a user uses the function of taking pictures in the daytime, he may use the filter transmitting visible light to filter other light except visible light to prevent producing noise. On the contrary, when a user engages in outdoor activities at night, he may switch to the filter transmitting infrared light, to provide the function of night vision, so that it will be favorable for the users to observe wild animals without disturbing them.

Furthermore, a lighting module is disposed additionally on the front end of the handheld electronic device, so that the user can use the GPS out of door at night and use the lighting function simultaneously.

Although the invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A handheld electronic device, comprising:
a body having a display and an opening
an image capturing module disposed at the body, the image capturing module comprising:
a lens disposed at the opening of the body, the image captured by the lens being displayed on the display; and
a filter unit disposed at the body to filter the light through the lens, the filter unit comprising at least a first filter, a second filter, and a switch, wherein the first filter and the second filter are suitable for transmitting the light with different wavelength respectively, and the switch is used to switch the first filter and the second filter, so that the first filter or the second filter is on the light receiving path of the lens.

2. The handheld electronic device according to claim 1, wherein the lens is a charge couple device (CCD) or a complementary metal-oxide-semiconductor (CMOS) sensor device.

3. The handheld electronic device according to claim 1, wherein the first filter transmits infrared light and filters out the light of other wave band, while the second filter transmits visible light.

4. The handheld electronic device according to claim 3, wherein the second filter transmits visible light and filters out the light of other wave band.

5. The handheld electronic device according to claim 1, further comprising:
a control circuit board disposed inside the body; and
a lighting module electrically connected to the control circuit board and exposed from the body.

6. The handheld electronic device according to claim 5, wherein the lighting module comprises at least a light-emitting diode (LED).

7. The handheld electronic device according to claim 6, wherein a recess is formed on the surface of the body to hold the LED.

8. The handheld electronic device according to claim 7, wherein the lighting module comprises a reflex housing, and the reflex housing is disposed in the recess to reflex the light from the LED.

9. The handheld electronic device according to claim 1, further comprising an auxiliary lighting module disposed at the body to provide an auxiliary light source when the image capturing module captures the image.

10. The handheld electronic device according to claim 9, wherein the auxiliary lighting module is adjacent to the image capturing module.

11. The handheld electronic device according to claim 9, wherein the auxiliary lighting module comprises at least an LED.

12. The handheld electronic device according to claim 11, wherein the LED is an infrared LED.

13. The handheld electronic device according to claim 1, further comprising a global positioning system (GPS) to produce the forecast of the geographic position of the handheld electronic device.
